(19) United States
(12) Patent Application Publication
(10) Pub. No.: US 2006/0069208 A1
(43) Pub. Date: Mar. 30, 2006

(54) Weatherable resinous composition with improved heat resistance

(75) Inventors: Sandeep Dhawan, Vienna, WV (US); Satish Kumar Gaggar, Parkersburg, WV (US); Patricia Bin Sun, Parkersburg, WV (US); Shripathy Vilasagar, Parkersburg, WV (US)

Correspondence Address: Henry H. Gibson;GE Plastics, One Plastics Avenue, Pittsfield, MA, 01201, US

(73) Assignee: General Electric Company

(21) Appl. No.: 10/953,724

(22) Filed: Sep. 29, 2004

(51) Int. Cl. C08F 8/00

(52) U.S. Cl. 525/191

(57) ABSTRACT

Disclosed are compositions comprising: (i) a rubber modified thermoplastic resin comprising a discontinuous elastomeric phase dispersed in a rigid thermoplastic phase, wherein at least a portion of the rigid thermoplastic phase is grafted to the elastomeric phase, and wherein the elastomeric phase comprises a polymer having structural units derived from at least one (C₁-C₁₂)alkyl(meth)acrylate monomer; (ii) a second polymer consisting essentially of structural units derived from at least one (C₁-C₁₂)alkyl(meth)acrylate monomer; and optionally (iii) a third polymer comprising structural units derived from at least one alkenyl aromatic monomer and at least one monoethylenically unsaturated nitrile monomer prepared in a separate polymerization step and added to the composition. In other embodiments the present invention comprises articles made from said compositions.

### BACKGROUND OF THE INVENTION

The present invention relates to a weatherable resinous composition which exhibits improved heat resistance. In particular embodiments the present invention relates to a composition comprising a rubber modified thermoplastic resin comprising a discontinuous elastomeric phase dispersed in a rigid thermoplastic phase, wherein at least a portion of the rigid thermoplastic phase is grafted to the elastomeric phase; which resin exhibits weatherability and improved heat resistance.

Resinous compositions such as acrylonitrile-styrene-acrylate (ASA) graft copolymers are often employed in applications which require long-term use in outdoor conditions under exposure to ultraviolet radiation and moisture. Resistance to such conditions is generally referred to as “weatherability”. However, many applications requiring weatherability also require high heat resistance, as measured, for example, by heat distortion temperature (HDT) or Vicat temperature. Blends based on poly(methyl methacrylate) (PMMA) as the continuous rigid phase and an impact modifier based on poly(butyl acrylate) (PBA) rubber are well-recognized as weatherable resins. However, these blends are also often characterized by relatively low impact strength and stiff flow, among other deficiencies. Many of the problems associated with such blends have been addressed by employing compositions with improved weatherability comprising methyl methacrylate-modified ASA, as disclosed, for example, in commonly assigned, copending application Ser. No. 10/434,914, filed May 9, 2003. However, these compositions often suffer from inadequate heat resistance for many applications. A problem to be solved is to provide a weatherable resinous composition with improved heat resistance, which retains an adequate balance of other properties.

### BRIEF DESCRIPTION OF THE INVENTION

The present inventors have discovered novel compositions which exhibit improved heat resistance, while maintaining other desirable physical properties, including weatherability. In one embodiment the present invention comprises a composition comprising: (i) a rubber modified thermoplastic resin comprising a discontinuous elastomeric phase dispersed in a rigid thermoplastic phase, wherein at least a portion of the rigid thermoplastic phase is grafted to the elastomeric phase, and wherein the elastomeric phase comprises a polymer having structural units derived from at least one (C₁-C₁₂)alkyl(meth)acrylate monomer; (ii) a second polymer consisting essentially of structural units derived from at least one (C₁-C₁₂)alkyl(meth)acrylate monomer; and optionally (iii) a third polymer comprising structural units derived from at least one alkenyl aromatic monomer and at least one monoethylenically unsaturated nitrile monomer prepared in a separate polymerization step and added to the composition. In other embodiments the present invention comprises articles made from said compositions. Various other features, aspects, and advantages of the present invention will become more apparent with reference to the following description and appended claims.

### BRIEF DESCRIPTION OF THE DRAWINGS

FIG. 1 shows a graph of delta E* versus exposure for compositions of the invention and comparative compositions comprising 33% ASA.

FIG. 2 shows a graph of delta E* versus exposure for compositions of the invention and comparative compositions comprising 50% ASA.

FIG. 3 shows a graph of delta E* versus exposure for compositions of the invention and comparative compositions comprising 67% ASA.

### DETAILED DESCRIPTION OF THE INVENTION

In the following specification and the claims which follow, reference will be made to a number of terms which shall be defined to have the following meanings. The singular forms “a”, “an” and “the” include plural referents unless the context clearly dictates otherwise. “Optional” or “optionally” means that the subsequently described event or circumstance may or may not occur, and that the description includes instances where the event occurs and instances where it does not. The terminology “monoethylenically unsaturated” means having a single site of ethylenic unsaturation per molecule. The terminology “polyethylenically unsaturated” means having two or more sites of ethylenic unsaturation per molecule. The terminology “(meth)acrylate” refers collectively to acrylate and methacrylate; for example, the term “(meth)acrylate monomers” refers collectively to acrylate monomers and methacrylate monomers. The term “(meth)acrylamide” refers collectively to acrylamides and methacrylamides.

The term “alkyl” as used in the various embodiments of the present invention is intended to designate linear alkyl, branched alkyl, aralkyl, cycloalkyl, bicycloalkyl, tricycloalkyl and polycycloalkyl radicals containing carbon and hydrogen atoms, and optionally containing atoms in addition to carbon and hydrogen, for example atoms selected from Groups 15, 16 and 17 of the Periodic Table. Alkyl groups may be saturated or unsaturated, and may comprise, for example, vinyl or allyl. The term “alkyl” also encompasses that alkyl portion of alkoxide groups. In various embodiments normal and branched alkyl radicals are those containing from 1 to about 32 carbon atoms, and include as illustrative non-limiting examples C₁-C₃₂ alkyl (optionally substituted with one or more groups selected from C₁-C₃₂ alkyl, C₃-C₁₅ cycloalkyl or aryl); and C₃-C₁₅ cycloalkyl optionally substituted with one or more groups selected from C₁-C₃₂ alkyl. Some particular illustrative examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some illustrative non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals are those containing from 7 to about 14 carbon atoms; these include, but are not limited to, benzyl, phenylbutyl, phenylpropyl, and phenylethyl. The term “aryl” as used in the various embodiments of the present invention is intended to designate substituted or unsubstituted aryl radicals containing from 6 to 20 ring carbon atoms. Some illustrative non-limiting examples of these aryl radicals include C₆-C₂₀ aryl optionally substituted with one or more groups selected from C₁-C₃₂ alkyl, C₃-C₁₅ cycloalkyl, aryl, and functional groups comprising atoms selected from Groups 15, 16 and 17 of the Periodic Table. Some particular illustrative examples of aryl radicals comprise substituted or unsubstituted phenyl, biphenyl, tolyl, naphthyl and binaphthyl.

Compositions of the present invention comprise a rubber modified thermoplastic resin comprising a discontinuous elastomeric phase dispersed in a rigid thermoplastic phase, wherein at least a portion of the rigid thermoplastic phase is grafted to the elastomeric phase. The rubber modified thermoplastic resin employs at least one rubber substrate for grafting. The rubber substrate comprises the discontinuous elastomeric phase of the composition. There is no particular limitation on the rubber substrate provided it is susceptible to grafting by at least a portion of a graftable monomer. In some embodiments suitable rubber substrates comprise dimethyl siloxane/butyl acrylate rubber, or silicone/butyl acrylate composite rubber; polyolefin rubbers such as ethylene-propylene rubber or ethylene-propylene-diene (EPDM) rubber; or silicone rubber polymers such as polymethyl siloxane rubber. The rubber substrate typically has a glass transition temperature, Tg, in one embodiment less than or equal to 25° C., in another embodiment below about 0° C., in another embodiment below about minus 20° C., and in still another embodiment below about minus 30° C. As referred to herein, the Tg of a polymer is the T value of polymer as measured by differential scanning calorimetry (DSC; heating rate 20° C./minute, with the Tg value being determined at the inflection point).

In one embodiment the rubber substrate is derived from polymerization by known methods of at least one monoethylenically unsaturated alkyl (meth)acrylate monomer selected from (C₁-C₁₂)alkyl(meth)acrylate monomers and mixtures comprising at least one of said monomers. As used herein, the terminology “(Cₓ-C_{y})”, as applied to a particular unit, such as, for example, a chemical compound or a chemical substituent group, means having a carbon atom content of from “x” carbon atoms to “y” carbon atoms per such unit. For example, “(C₁-C₁₂)alkyl” means a straight chain, branched or cyclic alkyl substituent group having from 1 to 12 carbon atoms per group. Suitable (C₁-C₁₂)alkyl(meth)acrylate monomers include, but are not limited to, (C₁-C₁₂)alkyl acrylate monomers, illustrative examples of which comprise ethyl acrylate, butyl acrylate, iso-pentyl acrylate, n-hexyl acrylate, and 2-ethyl hexyl acrylate; and their (C₁-C₁₂)alkyl methacrylate analogs, illustrative examples of which comprise methyl methacrylate, ethyl methacrylate, propyl methacrylate, iso-propyl methacrylate, butyl methacrylate, hexyl methacrylate, and decyl methacrylate. In a particular embodiment of the present invention the rubber substrate comprises structural units derived from n-butyl acrylate.

In various embodiments the rubber substrate may also optionally comprise a minor amount, for example up to about 5 wt. %, of structural units derived from at least one polyethylenically unsaturated monomer, for example those that are copolymerizable with a monomer used to prepare the rubber substrate. A polyethylenically unsaturated monomer is often employed to provide cross-linking of the rubber particles and/or to provide “graftlinking” sites in the rubber substrate for subsequent reaction with grafting monomers. Suitable polyethylenically unsaturated monomers include, but are not limited to, butylene diacrylate, divinyl benzene, butene diol dimethacrylate, trimethylolpropane tri(meth)acrylate, allyl methacrylate, diallyl methacrylate, diallyl maleate, diallyl fumarate, diallyl phthalate, triallyl methacrylate, triallyl cyanurate, triallyl isocyanurate, the acrylate of tricyclodecenylalcohol and mixtures comprising at least one of such monomers. In a particular embodiment the rubber substrate comprises structural units derived from triallyl cyanurate.

In some embodiments the rubber substrate may optionally comprise structural units derived from minor amounts of other unsaturated monomers, for example those that are copolymerizable with a monomer used to prepare the rubber substrate. In particular embodiments the rubber substrate may optionally include up to about 25 wt. % of structural units derived from one or more monomers selected from (meth)acrylate monomers, alkenyl aromatic monomers and monoethylenically unsaturated nitrile monomers. Suitable copolymerizable (meth)acrylate monomers include, but are not limited to, C₁-C₁₂ aryl or haloaryl substituted acrylate, C₁-C₁₂ aryl or haloaryl substituted methacrylate, or mixtures thereof; monoethylenically unsaturated carboxylic acids, such as, for example, acrylic acid, methacrylic acid and itaconic acid; glycidyl (meth)acrylate, hydroxy alkyl (meth)acrylate, hydroxy(C₁-C₁₂)alkyl (meth)acrylate, such as, for example, hydroxyethyl methacrylate; (C₄-C₁₂)cycloalkyl (meth)acrylate monomers, such as, for example, cyclohexyl methacrylate; (meth)acrylamide monomers, such as, for example, acrylamide, methacrylamide and N-substituted-acrylamide or N-substituted-methacrylamides; maleimide monomers, such as, for example, maleimide, N-alkyl maleimides, N-aryl maleimides, N-phenyl maleimide, and haloaryl substituted maleimides; maleic anhydride; methyl vinyl ether, ethyl vinyl ether, and vinyl esters, such as, for example, vinyl acetate and vinyl propionate. Suitable alkenyl aromatic monomers include, but are not limited to, vinyl aromatic monomers, such as, for example, styrene and substituted styrenes having one or more alkyl, alkoxy, hydroxy or halo substituent groups attached to the aromatic ring, including, but not limited to, alpha-methyl styrene, p-methyl styrene, 3,5-diethylstyrene, 4-n-propylstyrene, 4-isopropylstyrene, vinyl toluene, alpha-methyl vinyl toluene, vinyl xylene, trimethyl styrene, butyl styrene, t-butyl styrene, chlorostyrene, alpha-chlorostyrene, dichlorostyrene, tetrachlorostyrene, bromostyrene, alpha-bromostyrene, dibromostyrene, p-hydroxystyrene, p-acetoxystyrene, methoxystyrene and vinyl-substituted condensed aromatic ring structures, such as, for example, vinyl naphthalene, vinyl anthracene, as well as mixtures of vinyl aromatic monomers and monoethylenically unsaturated nitrile monomers such as, for example, acrylonitrile, ethacrylonitrile, methacrylonitrile, alpha-bromoacrylonitrile and alpha-chloro acrylonitrile. Substituted styrenes with mixtures of substituents on the aromatic ring are also suitable. As used herein, the term “monoethylenically unsaturated nitrile monomer” means an acyclic compound that includes a single nitrile group and a single site of ethylenic unsaturation per molecule and includes, but is not limited to, acrylonitrile, methacrylonitrile, alpha-chloro acrylonitrile, and the like.

In a particular embodiment the rubber substrate comprises repeating units derived from one or more (C₁-C₁₂)alkyl acrylate monomers. In still another particular embodiment, the rubber substrate comprises from 40 to 95 wt. % repeating units derived from one or more (C₁-C₁₂)alkyl acrylate monomers, and more preferably from one or more monomers selected from ethyl acrylate, butyl acrylate and n-hexyl acrylate.

The rubber substrate may be present in the rubber modified thermoplastic resin in one embodiment at a level of from about 4 wt. % to about 94 wt. %; in another embodiment at a level of from about 10 wt. % to about 80 wt. %; in another embodiment at a level of from about 15 wt. % to about 80 wt. %; in another embodiment at a level of from about 35 wt. % to about 80 wt. %; in another embodiment at a level of from about 40 wt. % to about 80 wt. %; in another embodiment at a level of from about 25 wt. % to about 60 wt. %, and in still another embodiment at a level of from about 40 wt. % to about 50 wt. %, based on the weight of the rubber modified thermoplastic resin. In other embodiments the rubber substrate may be present in the rubber modified thermoplastic resin at a level of from about 5 wt. % to about 50 wt. %; at a level of from about 8 wt. % to about 40 wt. %; or at a level of from about 10 wt. % to about 30 wt. %, based on the weight of the particular rubber modified thermoplastic resin.

There is no particular limitation on the particle size distribution of the rubber substrate (sometimes referred to hereinafter as initial rubber substrate to distinguish it from the rubber substrate following grafting). In some embodiments the initial rubber substrate may possess a broad, essentially monomodal, particle size distribution with particles ranging in size from about 50 nanometers (nm) to about 1000 nm. In other embodiments the mean particle size of the initial rubber substrate may be less than about 100 nm. In still other embodiments the mean particle size of the initial rubber substrate may be in a range of between about 80 nm and about 400 nm. In other embodiments the mean particle size of the initial rubber substrate may be greater than about 400 nm. In still other embodiments the mean particle size of the initial rubber substrate may be in a range of between about 400 nm and about 750 nm. In still other embodiments the initial rubber substrate comprises particles which are a mixture of particle sizes with at least two mean particle size distributions. In a particular embodiment the initial rubber substrate comprises a mixture of particle sizes with each mean particle size distribution in a range of between about 80 nm and about 750 nm. In another particular embodiment the initial rubber substrate comprises a mixture of particle sizes, one with a mean particle size distribution in a range of between about 80 nm and about 400 nm; and one with a broad and essentially monomodal mean particle size distribution.

The rubber substrate may be made according to known methods, such as, but not limited to, a bulk, solution, or emulsion process. In one non-limiting embodiment the rubber substrate is made by aqueous emulsion polymerization in the presence of a free radical initiator, e.g., an azonitrile initiator, an organic peroxide initiator, a persulfate initiator or a redox initiator system, and, optionally, in the presence of a chain transfer agent, e.g., an alkyl mercaptan, to form particles of rubber substrate.

The rigid thermoplastic resin phase of the rubber modified thermoplastic resin comprises one or more thermoplastic polymers. In one embodiment of the present invention monomers are polymerized in the presence of the rubber substrate to thereby form a rigid thermoplastic phase, at least a portion of which is chemically grafted to the elastomeric phase. The portion of the rigid thermoplastic phase chemically grafted to rubber substrate is sometimes referred to hereinafter as grafted copolymer. The rigid thermoplastic phase comprises a thermoplastic polymer or copolymer that exhibits a glass transition temperature (Tg) in one embodiment of greater than about 25° C., in another embodiment of greater than or equal to 90° C., and in still another embodiment of greater than or equal to 100° C.

In a particular embodiment the rigid thermoplastic phase comprises a polymer having structural units derived from one or more monomers selected from the group consisting of (C₁-C₁₂)alkyl-(meth)acrylate monomers, aryl-(meth)acrylate monomers, alkenyl aromatic monomers and monoethylenically unsaturated nitrile monomers. Suitable (C₁-C₁₂)alkyl-(meth)acrylate and aryl-(meth)acrylate monomers, alkenyl aromatic monomers and monoethylenically unsaturated nitrile monomers include those set forth hereinabove in the description of the rubber substrate. In addition, the rigid thermoplastic resin phase may, provided that the Tg limitation for the phase is satisfied, optionally include up to about 10 wt. % of third repeating units derived from one or more other copolymerizable monomers.

The rigid thermoplastic phase typically comprises one or more alkenyl aromatic polymers. Suitable alkenyl aromatic polymers comprise at least about 20 wt. % structural units derived from one or more alkenyl aromatic monomers. In one embodiment the rigid thermoplastic phase comprises an alkenyl aromatic polymer having structural units derived from one or more alkenyl aromatic monomers and from one or more monoethylenically unsaturated nitrile monomers. Examples of such alkenyl aromatic polymers include, but are not limited to, styrene/acrylonitrile copolymers, alpha-methylstyrene/acrylonitrile copolymers, or alpha-methylstyrene/styrene/acrylonitrile copolymers. In another particular embodiment the rigid thermoplastic phase comprises an alkenyl aromatic polymer having structural units derived from one or more alkenyl aromatic monomers; from one or more monoethylenically unsaturated nitrile monomers; and from one or more monomers selected from the group consisting of (C₁-C₁₂)alkyl- and aryl-(meth)acrylate monomers. Examples of such alkenyl aromatic polymers include, but are not limited to, styrene/acrylonitrile/methyl methacrylate copolymers, alpha-methylstyrene/acrylonitrile/methyl methacrylate copolymers and alpha-methylstyrene/styrene/acrylonitrile/methyl methacrylate copolymers. Further examples of suitable alkenyl aromatic polymers comprise styrene/methyl methacrylate copolymers, styrene/maleic anhydride copolymers; styrene/acrylonitrile/maleic anhydride copolymers, and styrene/acrylonitrile/acrylic acid copolymers. These copolymers may be used for the rigid thermoplastic phase either individually or as mixtures.

When structural units in copolymers are derived from one or more monoethylenically unsaturated nitrile monomers, then the amount of nitrile monomer added to form the copolymer comprising the grafted copolymer and the rigid thermoplastic phase may be in one embodiment in a range of between about 5 wt. % and about 40 wt. %, in another embodiment in a range of between about 5 wt. % and about 30 wt. %, in another embodiment in a range of between about 10 wt. % and about 30 wt. %, and in yet another embodiment in a range of between about 15 wt. % and about 30 wt. %, based on the total weight of monomers added to form the copolymer comprising the grafted copolymer and the rigid thermoplastic phase.

When structural units in copolymers are derived from one or more (C₁-C₁₂)alkyl- and aryl-(meth)acrylate monomers, then the amount of the said monomer added to form the copolymer comprising the grafted copolymer and the rigid thermoplastic phase may be in one embodiment in a range of between about 5 wt. % and about 50 wt. %, in another embodiment in a range of between about 5 wt. % and about 45 wt. %, in another embodiment in a range of between about 10 wt. % and about 35 wt. %, and in yet another embodiment in a range of between about 15 wt. % and about 35 wt. %, based on the total weight of monomers added to form the copolymer comprising the grafted copolymer and the rigid thermoplastic phase.

The amount of grafting that takes place between the rubber substrate and monomers comprising the rigid thermoplastic phase varies with the relative amount and composition of the rubber phase. In one embodiment, greater than about 10 wt. % of the rigid thermoplastic phase is chemically grafted to the rubber substrate, based on the total amount of rigid thermoplastic phase in the composition. In another embodiment, greater than about 15 wt. % of the rigid thermoplastic phase is chemically grafted to the rubber substrate, based on the total amount of rigid thermoplastic phase in the composition. In still another embodiment, greater than about 20 wt. % of the rigid thermoplastic phase is chemically grafted to the rubber substrate, based on the total amount of rigid thermoplastic phase in the composition. In particular embodiments the amount of rigid thermoplastic phase chemically grafted to the rubber substrate may be in a range of between about 5 wt. % and about 90 wt. %; between about 10 wt. % and about 90 wt. %; between about 15 wt. % and about 85 wt. %; between about 15 wt. % and about 50 wt. %; or between about 20 wt. % and about 50 wt. %, based on the total amount of rigid thermoplastic phase in the composition. In yet other embodiments, about 40 wt. % to 90 wt. % of the rigid thermoplastic phase is free, that is, non-grafted.

The rigid thermoplastic phase may be present in the rubber modified thermoplastic resin in one embodiment at a level of from about 85 wt. % to about 6 wt. %; in another embodiment at a level of from about 65 wt. % to about 6 wt. %; in another embodiment at a level of from about 60 wt. % to about 20 wt. %; in another embodiment at a level of from about 75 wt. % to about 40 wt. %, and in still another embodiment at a level of from about 60 wt. % to about 50 wt. %, based on the weight of the rubber modified thermoplastic resin. In other embodiments the rigid thermoplastic phase may be present in a range of between about 90 wt. % and about 30 wt. %, based on the weight of the rubber modified thermoplastic resin. Two or more different rubber substrates, each possessing a different mean particle size, may be separately employed in a polymerization reaction to prepare rigid thermoplastic phase, and then the products blended together to make the rubber modified thermoplastic resin. In illustrative embodiments wherein such products each possessing a different mean particle size of initial rubber substrate are blended together, then the ratios of said substrates may be in a range of about 90:10 to about 10:90, or in a range of about 80:20 to about 20:80, or in a range of about 70:30 to about 30:70. In some embodiments an initial rubber substrate with smaller particle size is the major component in such a blend containing more than one particle size of initial rubber substrate. In alternative embodiments the rigid thermoplastic phase may be formed solely by polymerization carried out in the presence of rubber substrate, or by addition of one or more separately synthesized rigid thermoplastic polymers to the rubber modified thermoplastic resin comprising the composition, or by a combination of both processes.

The rigid thermoplastic phase may be made according to known processes, for example, mass polymerization, emulsion polymerization, suspension polymerization or combinations thereof, wherein at least a portion of the rigid thermoplastic phase is chemically bonded, i.e., “grafted” to the rubber phase via reaction with unsaturated sites present in the rubber phase. The grafting reaction may be performed in a batch, continuous or semi-continuous process. Representative procedures include, but are not limited to, those taught in U.S. Pat. No. 3,944,631; and in U.S. patent application Ser. No. 08/962,458, filed Oct. 31, 1997. The unsaturated sites in the rubber phase are provided, for example, by residual unsaturated sites in those structural units of the rubber that were derived from a graftlinking monomer. In some embodiments of the present invention monomer grafting to rubber substrate with concomitant formation of rigid thermoplastic phase may optionally be performed in stages wherein at least one first monomer is grafted to rubber substrate followed by at least one second monomer different from said first monomer. Representative procedures for staged monomer grafting to rubber substrate include, but are not limited to, those taught in commonly assigned U.S. patent application Ser. No. 10/748,394, filed Dec. 30, 2003.

In a preferred embodiment the rubber modified thermoplastic resin is an ASA graft copolymer such as that manufactured and sold by General Electric Company under the trademark GELOY®, or an acrylate-modified acrylonitrile-styrene-acrylate graft copolymer. ASA polymeric materials include, for example, those disclosed in U.S. Pat. No. 3,711,575. Acrylonitrile-styrene-acrylate graft copolymers comprise those described in commonly assigned U.S. Pat. Nos. 4,731,414 and 4,831,079. In some embodiments of the invention where an acrylate-modified ASA is used, the ASA component further comprises an additional acrylate-graft formed from monomers selected from the group consisting of C₁ to C₁₂ alkyl- and aryl-(meth)acrylate as part of either the rigid phase, the rubber phase, or both. Such copolymers are referred to as acrylate-modified acrylonitrile-styrene-acrylate graft copolymers, or acrylate-modified ASA. A preferred monomer is methyl methacrylate to result in a PMMA-modified ASA (sometimes referred to hereinafter as “MMA-ASA”).

Compositions of the invention also comprise a second polymer comprising structural units derived from at least one (C₁-C₁₂)alkyl(meth)acrylate monomer, sometimes referred to herein as “acrylic polymers”. In a particular embodiment compositions of the invention comprise a second polymer consisting essentially of structural units derived from at least one (C₁-C₁₂)alkyl(meth)acrylate monomer. In the present context consisting essentially of structural units derived from at least one (C₁-C₁₂)alkyl(meth)acrylate monomer means that the second polymer comprises in one embodiment greater than 90% of said structural units; in another embodiment greater than 95% of said structural units; in still another embodiment greater than 98% of said structural units; and in still another embodiment greater than 99% of said structural units. Suitable (C₁-C₁₂)alkyl(meth)acrylate monomers for use in the said polymers comprise those (C₁-C₁₂)alkyl(meth)acrylate monomers described hereinabove. In particular embodiments suitable (C₁-C₁₂)alkyl(meth)acrylate monomers include, but are not limited to, (C₁-C₁₂)alkyl acrylate monomers, illustrative examples of which comprise ethyl acrylate, butyl acrylate, iso-pentyl acrylate, n-hexyl acrylate, and 2-ethyl hexyl acrylate; and their (C₁-C₁₂)alkyl methacrylate analogs, illustrative examples of which comprise methyl methacrylate, ethyl methacrylate, propyl methacrylate, iso-propyl methacrylate, butyl methacrylate, hexyl methacrylate, and decyl methacrylate. In a particular embodiment the polymer comprises structural units derived from methyl methacrylate (said polymer being known as poly(methyl methacrylate) or PMMA). The amount of said second polymer in compositions of the invention may be in one embodiment in a range of between about 3 wt. % and about 70 wt. %, in another embodiment in a range of between about 3 wt. % and about 67 wt. %, in another embodiment in a range of between about 3 wt. % and about 60 wt. %, in another embodiment in a range of between about 3 wt. % and about 55 wt. %, in another embodiment in a range of between about 5 wt. % and about 55 wt. %, in another embodiment in a range of between about 8 wt. % and about 52 wt. %, in another embodiment in a range of between about 10 wt. % and about 50 wt. %, in another embodiment in a range of between about 10 wt. % and about 45 wt. %, in another embodiment in a range of between about 10 wt. % and about 40 wt. %, and in still another embodiment in a range of between about 15 wt. % and about 35 wt. %, based on the weight of resinous components in the composition. In another particular embodiment the amount of said second polymer in compositions of the invention may be in a range of between about 12 wt. % and about 55 wt. %, based on the weight of resinous components in the composition.

Compositions of the invention may optionally comprise a third polymer comprising structural units derived from at least one alkenyl aromatic monomer and at least one monoethylenically unsaturated nitrile monomer prepared in a separate polymerization step and added to the composition. In a particular embodiment said third polymer consists essentially of structural units derived from at least one alkenyl aromatic monomer and at least one monoethylenically unsaturated nitrile monomer prepared in a separate polymerization step and added to the composition. In the present context consisting essentially of structural units derived from derived from at least one alkenyl aromatic monomer and at least one monoethylenically unsaturated nitrile monomer means that the third polymer comprises in one embodiment greater than 90% of said structural units; in another embodiment greater than 95% of said structural units; in still another embodiment greater than 98% of said structural units; and in still another embodiment greater than 99% of said structural units. In another particular embodiment said third polymer is free of structural units derived from at least one (C₁-C₁₂)alkyl(meth)acrylate monomer. Said third polymer may be prepared by known methods. In some embodiments said third polymer comprises structural units essentially identical to those of the rigid thermoplastic phase comprising the rubber modified thermoplastic resin. In some particular embodiments said third polymer comprises structural units derived from styrene and acrylonitrile; alpha-methylstyrene and acrylonitrile; or alpha-methylstyrene, styrene, and acrylonitrile. When present, the amount of said third polymer is in one embodiment in a range of between about 3 wt. % and about 55 wt. %, in another embodiment in a range of between about 5 wt. % and about 45 wt. %, and in still another embodiment in a range of between about 5 wt. % and about 40 wt. %, based on the weight of resinous components in the composition. When both the second polymer and the third polymer are present in the compositions, then they may be present at a combined level in a range of between about 5% and about 85% based on the weight of resinous components in the composition.

Compositions of the present invention may optionally comprise additives known in the art including, but not limited to, stabilizers, such as color stabilizers, heat stabilizers, light stabilizers, antioxidants, UV screeners, and UV absorbers; flame retardants, anti-drip agents, lubricants, flow promoters and other processing aids; plasticizers, antistatic agents, mold release agents, impact modifiers, fillers, and colorants such as dyes and pigments which may be organic, inorganic or organometallic; and like additives. Illustrative additives include, but are not limited to, silica, silicates, zeolites, titanium dioxide, stone powder, glass fibers or spheres, carbon fibers, carbon black, graphite, calcium carbonate, talc, lithopone, zinc oxide, zirconium silicate, iron oxides, diatomaceous earth, calcium carbonate, magnesium oxide, chromic oxide, zirconium oxide, aluminum oxide, crushed quartz, clay, calcined clay, talc, kaolin, asbestos, cellulose, wood flour, cork, cotton and synthetic textile fibers, especially reinforcing fillers such as glass fibers, carbon fibers, metal fibers, and metal flakes, including, but not limited to aluminum flakes. Often more than one additive is included in compositions of the invention, and in some embodiments more than one additive of one type is included. In a particular embodiment a composition further comprises an additive selected from the group consisting of colorants, dyes, pigments, lubricants, stabilizers, heat stabilizers, light stabilizers, antioxidants, UV screeners, UV absorbers, fillers and mixtures thereof.

In a particular embodiment compositions of the invention may optionally comprise mixtures of at least one metal salt of a fatty acid and at least one amide. The fatty acids generally comprise from 16 to 18 carbon atoms. Representative examples include stearic acid, oleic acid, palmitic acid and mixtures thereof. In a preferred embodiment the fatty acid comprises stearic acid. Fatty acid mixtures may additionally comprise 9,12-linoleic acid, 9,11-linoleic acid (conjugated linoleic acid), pinolenic acid, palmitoleic acid, magaric acid, octadecadienoic acid, octadecatrienoic acid, and the like. Fatty acid mixtures may contain minor amounts of rosin acids. Illustrative rosin acids include, but are not limited to, those generally found in tall oil fatty acid mixtures, and may comprise abietic acid, dihydroabietic acid, palustric/levopimaric acid, pimaric acids, tetrahydroabietic acid, isopimaric acid, neoabietic acid, and the like. Suitable metal salts include, but are not limited to, those comprising aluminum, magnesium, calcium, and zinc, and mixtures thereof. In some embodiments suitable amides comprise those derived from C₈-C₁₈ carboxylic acids and hydroxy-substituted amines. The ratio of fatty acid metal salt to amide component in the mixture is that which is effective to obtain a reduction in plate-out in compositions of the invention. Mixtures of at least one metal salt of a fatty acid and at least one amide may be prepared by mixing the individual components. Commercial mixtures suitable for use in compositions of the present invention comprise those available from Struktol Company of America (Stow, Ohio), including, but are not limited to, STRUKTOL TR 251, STRUKTOL TR 255, STRUKTOL TR 071, and STRUKTOL TR 016. In various embodiments the amount of said mixture in compositions of the invention may be in a range of between 0 phr and about 5 phr, or in a range of between about 0.2 phr and about 4 phr, or in a range of between about 0.5 phr and about 4 phr, or in a range of between about 1 phr and about 3 phr.

Compositions of the invention and articles made therefrom may be prepared by known thermoplastic processing techniques. Known thermoplastic processing techniques which may be used include, but are not limited to, extrusion, calendering, kneading, profile extrusion, sheet extrusion, coextrusion, molding, extrusion blow molding, thermoforming, injection molding, co-injection molding and rotomolding. The invention further contemplates additional fabrication operations on said articles, such as, but not limited to, in-mold decoration, baking in a paint oven, surface etching, lamination, and/or thermoforming.

The compositions of the present invention can be formed into useful articles. In some embodiments the articles comprise unitary articles. Illustrative unitary articles comprise those consisting essentially of a composition of the present invention. In still other embodiments the articles may comprise multilayer articles comprising at least one layer comprising a composition of the present invention. In various embodiments multilayer articles may comprise a cap-layer comprising a composition of the invention and a substrate layer comprising at least one thermoplastic resin different from said cap-layer. In some particular embodiments said substrate layer comprises at least one of an acrylic polymer; PMMA; a rubber-modified acrylic polymer; rubber-modified PMMA; ASA; poly(vinyl chloride) (PVC); acrylonitrile-butadiene-styrene copolymer (ABS); polycarbonate (PC); and mixtures comprising at least one of the aforementioned materials, including, but not limited to, mixtures of ASA and PC; mixtures of ABS and PC; mixtures of ABS and an acrylic polymer; and mixtures of ABS and PMMA. In some particular embodiments PC consists essentially of bisphenol A polycarbonate. In addition in some embodiments said multilayer article may comprise at least one substrate layer and at least one tielayer between said substrate layer and said cap-layer. Additional illustrative examples of resins suitable for substrate layers comprise polyesters, such as poly(alkylene terephthalates), poly(alkylene naphthalates), poly(ethylene terephthalate), poly(butylene terephthalate), poly(trimethylene terephthalate), poly(ethylene naphthalate), poly(butylene naphthalate), poly(cyclohexanedimethanol terephthalate), poly(cyclohexanedimethanol-co-ethylene terephthalate), poly(1,4-cyclohexane-dimethyl-1,4-cyclohexanedicarboxylate), polyarylates, the polyarylate with structural units derived from resorcinol and a mixture of iso- and terephthalic acids, polyestercarbonates, the polyestercarbonate with structural units derived from bisphenol A, carbonic acid and a mixture of iso- and terephthalic acids, the polyestercarbonate with structural units derived from resorcinol, carbonic acid and a mixture of iso- and terephthalic acids, and the polyestercarbonate with structural units derived from bisphenol A, resorcinol, carbonic acid and a mixture of iso- and terephthalic acids. Additional illustrative examples of resins suitable for substrate layers further comprise aromatic polyethers such as polyarylene ether homopolymers and copolymers such as those comprising 2,6-dimethyl-1,4-phenylene ether units, optionally in combination with 2,3,6-trimethyl-1,4-phenylene ether units; polyetherimides, polyetherketones, polyetheretherketones, polyethersulfones; polyarylene sulfides and sulfones, such as polyphenylene sulfides, polyphenylene sulfones, and copolymers of polyphenylene sulfides with polyphenylene sulfones; polyamides, such as poly(hexamethylene adipamide) and poly(ε-aminocaproamide); polyolefin homopolymers and copolymers, such as polyethylene, polypropylene, and copolymers containing at least one of ethylene and propylene; polyacrylates, poly(methyl methacrylate), poly(ethylene-co-acrylate)s including SURLYN; polystyrene, syndiotactic polystyrene, poly(styrene-co-acrylonitrile), poly(styrene-co-maleic anhydride); and compatibilized blends comprising at least one of any of the aforementioned resins, such as thermoplastic polyolefin (TPO); poly(phenylene ether)-polystyrene, poly(phenylene ether)-polyamide, poly(phenylene ether)-polyester, poly(butylene terephthalate)-polycarbonate, poly(ethylene terephthalate)-polycarbonate, polycarbonate-polyetherimide, and polyester-polyetherimide. Suitable substrate layers may comprise recycled or reground thermoplastic resin. Multilayer articles comprising a cap-layer comprised of a composition of the present invention may exhibit improved weatherability compared to similar articles without said cap-layer.

Multilayer and unitary articles which can be made which comprise compositions of the present invention include, but are not limited to, articles for outdoor vehicle and device (OVAD) applications; exterior and interior components for aircraft, automotive, truck, military vehicle (including automotive, aircraft, and water-bome vehicles), scooter, and motorcycle, including panels, quarter panels, rocker panels, vertical panels, horizontal panels, trim, pillars, center posts, fenders, doors, decklids, trunklids, hoods, bonnets, roofs, bumpers, fascia, grilles, mirror housings, pillar appliques, cladding, body side moldings, wheel covers, hubcaps, door handles, spoilers, window frames, headlamp bezels and housings, tail lamp housings, tail lamp bezels, license plate enclosures, roof racks, and running boards; enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as gutters, handrails, pricing channels, corner guards, down spouts, glazing, fencing, fence posts, decking planks, roofs; siding, particularly vinyl siding applications; windows, window frames, floors, decorative window furnishings or treatments; wall panels, doors and door frames; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; mobile phone housings; radio sender housings; radio receiver housings; light fixtures; light switches; electrical sockets; lighting appliances; reflectors; network interface device housings; transformer housings; air conditioner housings; cladding or seating for public transportation; cladding or seating for trains, subways, or buses; meter housings; antenna housings; cladding for satellite dishes; and like applications. Said articles may be prepared by a variety of known processes and fabrication steps which include, but are not limited to, profile extrusion, sheet extrusion, coextrusion, calendering, extrusion blow molding, thermoforming, injection molding, compression molding, in-mold decoration, baking in a paint oven, plating, and lamination.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

In the following examples resinous components are expressed in wt. %. Non-resinous components are expressed in phr. The abbreviation “C. Ex.” means Comparative Example. Vicat B values were determined according to ISO 306. HDT values in ° C. were determined according to ISO 179. Values for melt flow rate in grams per 10 minutes were determined at 220° C. using a weight of 10 kilograms according to ISO 1133. Viscosity values in units of pascal·seconds were determined at various shear rates using a Kayeness capillary rheometer under conditions of 260° C. melt temperature. Molded test specimens were subjected to color measurements in the CIE L*a*b* space using a MacBeth 7000 spectrophotometer for color measurement.

### EXAMPLES 1-8 AND COMPARATIVE EXAMPLES 1-7

In the compositions of the following examples and comparative examples ASA was a copolymer comprising structural units derived from 37.5 wt. % styrene, 18 wt. % acrylonitrile, and about 44.5 wt. % butyl acrylate. MMA-ASA was a copolymer comprising structural units derived from about 11 wt. % methyl methacrylate, about 30 wt. % styrene, about 14 wt. % acrylonitrile, and about 45 wt. % butyl acrylate. The types of SAN employed were SAN-1, a copolymer comprising 75 wt. % styrene and 25 wt. % acrylonitrile; and SAN-2, a copolymer comprising 72 wt. % styrene and 28 wt. % acrylonitrile with a weight average molecular weight (Mw) of about 100,000 made by a bulk polymerization process. MMA-SAN was a copolymer comprising structural units derived from 35 wt. % methyl methacrylate, 40 wt. % styrene, and 25 wt. % acrylonitrile made by a bulk polymerization process. All of the compositions comprised 1 phr ethylene bis-stearamide (EBS) wax; 1.4 phr of a mixture of hindered phenolic anti-oxidants, ultraviolet light absorbers, and phosphorus-comprising stabilizers; and 5 phr titanium dioxide. Properties of molded test parts are shown in the table. Examples 6, 7, and 8 are replicates of the same composition, and may all be compared to Comparative Example 6.

TABLE 1

| Component | C. Ex. 1 | Ex. 1 | C. Ex. 2 | Ex. 2 | C. Ex. 3 | Ex. 3 | C. Ex. 4 | Ex. 4 | C. Ex. 5 | Ex. 5 | C. Ex. 6 | Ex. 6 | Ex. 7 | Ex. 8 | C. Ex. 7 |
|---|---|---|---|---|---|---|---|---|---|---|---|---|---|---|---|
| ASA | 33.3 | 33.3 | 50 | 50 | 66.7 | 66.7 | — | — | — | — | — | — | — | — | 60 |
| MMA- | — | — | — | — | — | — | 33.3 | 33.3 | 66.7 | 66.7 | 50 | 50 | 50 | 50 | — |
| ASA | | | | | | | | | | | | | | | |
| SAN-1 | — | 35.6 | — | 26.7 | — | 17.8 | — | 35.6 | — | 17.8 | — | 26.7 | 26.7 | 26.7 | — |
| SAN-2 | — | — | — | — | — | — | — | — | — | — | — | — | — | — | 40 |
| MMA- | 66.7 | — | 50 | — | 33.3 | — | 66.7 | — | 33.3 | — | 50 | — | — | — | — |
| SAN | | | | | | | | | | | | | | | |
| PMMA | — | 31.1 | — | 23.3 | — | 15.5 | — | 31.1 | — | 15.5 | — | 23.3 | 23.3 | 23.3 | — |
| Vicat, ° C. | 95.4 | 98.8 | 93.4 | 95.6 | 87.0 | 90.2 | 95.0 | 98.2 | 85.9 | 89.0 | 91.9 | 94.4 | 94.6 | 94.4 | 89.8 |
| HDT, ° C. | 89.2 | 93.8 | 90.4 | 92.8 | 91.7 | 92.9 | 89.0 | 91.8 | 88.8 | 90.6 | 88.4 | 89.4 | 92.4 | 92.2 | 88.8 |
| MFR, | 18.9 | 23.9 | 8.4 | 13.4 | 4.2 | 4.7 | 17.9 | 24.9 | 3.3 | 5.3 | 8.2 | 8.2 | 11.8 | 12.8 | 5 |
| g/10 min. | | | | | | | | | | | | | | | |
| Viscosity, | | | | | | | | | | | | | | | |
| Pa · s | | | | | | | | | | | | | | | |
| at 100 s−1 | 610 | 413 | 776 | 592 | 844 | 844 | 598 | 435 | 882 | 926 | 677 | 754 | 624 | 627 | 918 |
| at 1000 s−1 | 162 | 133 | 192 | 158 | 192 | 190 | 160 | 134 | 202 | 201 | 174 | 182 | 165 | 162 | 201 |
| at 1500 s−1 | 124 | 104 | 146 | 121 | 145 | 143 | 122 | 105 | 152 | 151 | 133 | 138 | 126 | 124 | 151 |

Compositions of the invention comprising ASA, SAN, and PMMA show consistently higher HDT values and Vicat temperatures than do comparative compositions comprising ASA and MMA-SAN. Compositions comprising ASA, SAN, and PMMA also show consistently higher melt flow rate and lower viscosity than do similar compositions comprising ASA and MMA-SAN, resulting is better flow and ease of processability. Compositions of the invention comprising MMA-ASA, SAN, and PMMA show consistently higher HDT and Vicat temperatures than do comparative compositions comprising MMA-ASA and MMA-SAN. Also, in most cases compositions comprising MMA-ASA, SAN, and PMMA also show higher melt flow rate and lower viscosity than do similar compositions comprising MMA-ASA and MMA-SAN, resulting is better flow and ease of processability.

### EXAMPLES 9-18 AND COMPARATIVE EXAMPLE 8

In the compositions of the following examples and comparative examples MMA-ASA-1 was a copolymer comprising structural units derived from about 9 wt. % methyl methacrylate, about 32 wt. % styrene, about 15 wt. % acrylonitrile, and about 45 wt. % butyl acrylate, wherein the initial rubber particle size was about 110 nm. MMA-ASA-2 was a copolymer comprising structural units derived from about 9 wt. % methyl methacrylate, about 32 wt. % styrene, about 15 wt. % acrylonitrile, and about 45 wt. % butyl acrylate, wherein the initial rubber particle size was about 500 nm. MMA-ASA-3 was a copolymer comprising structural units derived from about 1 wt. % methyl methacrylate, about 30 wt. % styrene, about 14 wt. % acrylonitrile, and about 45 wt. % butyl acrylate, wherein the initial rubber particle size distribution was broad and essentially monomodal. The type of SAN employed was SAN-1, a copolymer comprising 75 wt. % styrene and 25 wt. % acrylonitrile. MMA-SAN was a copolymer comprising structural units derived from 35 wt. % methyl methacrylate, 40 wt. % styrene, and 25 wt. % acrylonitrile. All of the compositions comprised 0.5 phr ethylene bis-stearamide (EBS) wax; 1.5 phr of a mixture of hindered phenolic anti-oxidants, ultraviolet light absorbers, and phosphorus-comprising stabilizers; 0.1 phr silicone oil; and 1 phr carbon black. Properties of molded test parts are shown in the table. Examples 9, 10, and 11 are replicates of the same composition, and may all be compared to Comparative Example 8.

TABLE 2

| Component | C. Ex. 8 | Ex. 9 | Ex. 10 | Ex. 11 | Ex. 12 | Ex. 13 | Ex. 14 | Ex. 15 | Ex. 16 | Ex. 17 | Ex. 18 |
|---|---|---|---|---|---|---|---|---|---|---|---|
| MMA- | 33.8 | 33.8 | 33.8 | 33.8 | 30 | 30 | 33.8 | 37.5 | 37.5 | — | — |
| ASA-1 | | | | | | | | | | | |
| MMA- | 11.2 | 11.2 | 11.2 | 11.2 | 10 | 10 | 11.2 | 12.5 | 12.5 | — | — |
| ASA-2 | | | | | | | | | | | |
| MMA- | — | — | — | — | — | — | — | — | — | 40 | 45 |
| ASA-3 | | | | | | | | | | | |
| SAN-1 | — | 27.5 | 27.5 | 27.5 | 30 | 15 | 13.8 | 25 | 12.5 | 15 | 13.8 |
| PMMA | — | 27.5 | 27.5 | 27.5 | 30 | 45 | 41.2 | 25 | 37.5 | 45 | 41.2 |
| MMA-SAN | 55 | — | — | — | — | — | — | — | — | — | — |
| % rubber | 20.2 | 20.2 | 20.2 | 20.2 | 18 | 18 | 20.2 | 22.5 | 22.5 | 18 | 20.2 |
| PMMA:SAN | — | 50:50 | 50:50 | 50:50 | 50:50 | 75:25 | 75:25 | 50:50 | 75:25 | 75:25 | 75:25 |
| ratio | | | | | | | | | | | |
| HDT, ° C. | 88.9 | 91.0 | 90.6 | 91.1 | 92.4 | 90.6 | 91.7 | 90.8 | 89.4 | 91.6 | 90.2 |
| MFR, | 6.5 | 7.0 | 9.0 | 9.6 | 10.2 | 7.6 | 4.7 | 5.7 | 2.3 | 11.9 | 9.4 |
| g/10 min. | | | | | | | | | | | |
| Viscosity, | | | | | | | | | | | |
| Pa · s | | | | | | | | | | | |
| at 100 s−1 | 862 | 757 | 691 | 669 | 638 | 763 | 861 | 792 | 1004 | 614 | 667 |
| at 1000 s−1 | 206 | 194 | 184 | 180 | 177 | 191 | 213 | 200 | 229 | 171 | 177 |
| L* excluded | 7.6 | 6.6 | 7.0 | 6.5 | 6.3 | 5.7 | 6.0 | 6.6 | 5.7 | 7.6 | 7.6 |

Compositions of the invention comprising MMA-ASA, SAN, and PMMA in Examples 9-11 show higher HDT values than does the composition of Comparative Example 8 of similar composition comprising MMA-ASA and MMA-SAN. Compositions comprising MMA-ASA, SAN, and PMMA in Examples 9-11 also show higher melt flow rate and lower viscosity than does the composition of Comparative Example 8 of similar composition comprising MMA-ASA and MMA-SAN, resulting is better flow and ease of processability. The depth of black color or “jetness” of compositions comprising MMA-ASA, SAN, and PMMA in Examples 9-11 is also superior, as seen in the lower L* excluded value compared to the L* excluded value for a similar composition comprising MMA-ASA and MMA-SAN (Comparative Example 8).

### EXAMPLES 19-31 AND COMPARATIVE EXAMPLES 9-11

In the compositions of the following examples and comparative examples ASA was a copolymer comprising structural units derived from 37.5 wt. % styrene, 18 wt. % acrylonitrile, and about 44.5 wt. % butyl acrylate. The type of SAN employed was SAN-1, a copolymer comprising 75 wt. % styrene and 25 wt. % acrylonitrile. MMA-SAN was a copolymer comprising structural units derived from 35 wt. % methyl methacrylate, 40 wt. % styrene, and 25 wt. % acrylonitrile. All of the compositions comprised 0.5 phr ethylene bis-stearamide (EBS) wax; 1.5 phr of a mixture of hindered phenolic anti-oxidants, ultraviolet light absorbers, and phosphorus-comprising stabilizers; 0.1 phr silicone oil; and 1 phr carbon black. Properties of molded test parts are shown in the table. Examples 23-24 are replicates of the same composition.

TABLE 3

| | C. Ex. | Ex. | Ex. | Ex. | C. Ex. | Ex. | Ex. | Ex. | Ex. | C. Ex. | Ex. | Ex. | Ex. | Ex. | Ex. | Ex. |
|---|---|---|---|---|---|---|---|---|---|---|---|---|---|---|---|---|
| Component | 9 | 19 | 20 | 21 | 10 | 22 | 23 | 24 | 25 | 11 | 26 | 27 | 28 | 29 | 30 | 31 |
| ASA | 70 | 70 | 70 | 70 | 55 | 55 | 55 | 55 | 55 | 40 | 40 | 40 | 40 | 33 | 50 | 67 |
| SAN-1 | — | 18 | 12 | 6 | — | 27 | 18 | 18 | 9 | — | 36 | 24 | 12 | — | — | — |
| PMMA | — | 12 | 18 | 24 | — | 18 | 27 | 27 | 36 | — | 24 | 36 | 48 | 67 | 50 | 33 |
| MMA-SAN | 30 | — | — | — | 45 | — | — | — | — | 60 | — | — | — | — | — | — |
| Vicat, ° C. | 89.7 | 89.2 | 89.6 | 90.1 | 94.4 | 96.0 | 95.5 | 94.2 | 99.0 | 94.0 | 97.4 | 96.7 | 98.5 | 94.6 | 95.3 | 90.0 |
| ° C. | | | | | | | | | | | | | | | | |
| HDT,° C. | 90.1 | 92.3 | 92.6 | 92.2 | 89.8 | 93.3 | 93.3 | 92.6 | 91.7 | 89.6 | 93.4 | 92.6 | 92.5 | 90.8 | 91.2 | 91.8 |
| MFR, | 4.1 | 4.1 | 3.3 | 2.7 | 9.1 | 10.7 | 8.2 | 8.1 | 6.5 | 15.8 | 16.5 | 13.8 | 11.0 | 12.8 | 6.9 | 4.2 |
| g/10 min. | | | | | | | | | | | | | | | | |
| Viscosity, | | | | | | | | | | | | | | | | |
| Pa · s | | | | | | | | | | | | | | | | |
| at 100 s−1 | 638 | 777 | 810 | 777 | 771 | 537 | 606 | 596 | 591 | 507 | 376 | 434 | 476 | 502 | 566 | 844 |
| at 1000 s−1 | 164 | 183 | 189 | 181 | 183 | 148 | 163 | 158 | 157 | 147 | 124 | 137 | 146 | 151 | 157 | 193 |
| L* excluded | 9.0 | 12.5 | 10.9 | 9.1 | 8.4 | 8.9 | 8.1 | 8.0 | 7.5 | 7.4 | 7.8 | 7.5 | 7.0 | — | 7.1 | — |

Compositions of the invention comprising ASA and different ratios of SAN and PMMA show generally higher HDT values and Vicat temperatures than do the corresponding Comparative Examples of similar composition comprising ASA and MMA-SAN. The depth of black color or “jetness” of compositions comprising ASA, SAN, and PMMA improves as the level of PMMA increases, as seen in the lower L* excluded value.

### EXAMPLES 32-42 AND COMPARATIVE EXAMPLE 12

In the compositions of the following examples and comparative examples MMA-ASA-1, MMA-ASA-2 and MMA-ASA-3, SAN-1, and MMA-SAN were as described in examples above. All of the compositions comprised 0.5 phr ethylene bis-stearamide (EBS) wax; 1.5 phr of a mixture of hindered phenolic anti-oxidants, ultraviolet light absorbers, and phosphorus-comprising stabilizers; 0.1 phr silicone oil; and 1 phr carbon black. Properties of molded test parts are shown in the table.

TABLE 4

| Component | C. Ex. 12 | Ex. 32 | Ex. 33 | Ex. 34 | Ex. 35 | Ex. 36 | Ex. 37 | Ex. 38 | Ex. 39 | Ex. 40 | Ex. 41 | Ex. 42 |
|---|---|---|---|---|---|---|---|---|---|---|---|---|
| MMA- | 33.8 | 27 | 18 | 30 | 20 | 33 | 22 | 41.2 | — | — | — | — |
| ASA-1 | | | | | | | | | | | | |
| MMA- | 11.2 | — | — | — | — | — | — | 13.8 | — | — | — | — |
| ASA-2 | | | | | | | | | | | | |
| MMA- | — | 18 | 27 | 20 | 30 | 22 | 33 | — | 55 | 33 | 50 | 67 |
| ASA-3 | | | | | | | | | | | | |
| SAN-1 | — | 27.5 | 27.5 | 25 | 25 | 22.5 | 22.5 | 22.5 | 22.5 | — | — | — |
| PMMA | — | 27.5 | 27.5 | 25 | 25 | 22.5 | 22.5 | 22.5 | 22.5 | 67 | 50 | 33 |
| MMA-SAN | 55 | — | — | — | — | — | — | — | — | — | — | — |
| HDT, ° C. | 88.9 | 92.8 | 91.4 | 91.4 | 92.3 | 90.6 | 90.6 | 91.3 | 91.9 | 89.0 | 88.2 | 88.0 |
| MFR, | 6.5 | 8.8 | 9.9 | 5.2 | 6.1 | 3.9 | 4.9 | 3.9 | 6.9 | 12.7 | 8.3 | 3.9 |
| g/10 min. | | | | | | | | | | | | |
| Viscosity, | | | | | | | | | | | | |
| Pa · s | | | | | | | | | | | | |
| at 100 s−1 | 862 | 728 | 709 | 855 | 816 | 990 | 900 | 966 | 805 | 497 | 644 | 945 |
| at 1000 s−1 | 206 | 186 | 183 | 203 | 195 | 220 | 205 | 220 | 190 | 150 | 168 | 204 |
| L* excluded | 7.6 | 7.6 | 8.0 | 7.1 | 7.9 | 7.5 | 8.4 | 7.9 | 10.3 | — | — | — |

Compositions of the invention comprising SAN, PMMA and a mixture of MMA-ASA types with two different particle size distributions show excellent HDT values and good flow. The compositions of the invention also show there is an benefit to depth of black color or “jetness” as seen in the lower L* excluded value in compositions of the invention when a mixture of MMA-ASA types with two different particle size distributions is used in place of MMA-ASA with broad particle size distribution alone (Example 10).

### EXAMPLES 43-56

In the compositions of the following examples and comparative examples ASA was a copolymer comprising structural units derived from 37.5 wt. % styrene, 18 wt. % acrylonitrile, and about 44.5 wt. % butyl acrylate. The types of SAN employed were SAN-2, a copolymer comprising 72 wt. % styrene and 28 wt. % acrylonitrile with Mw of about 100,000 made by a bulk polymerization process; and SAN-3, a copolymer comprising 72 wt. % styrene and 28 wt. % acrylonitrile with Mw of about 160,000-180,000 made by a bulk polymerization process. All of the compositions comprised 0.5 phr EBS wax; 1.5 phr of a mixture of hindered phenolic anti-oxidants, ultraviolet light absorbers, and phosphorus-comprising stabilizers; 0.1 phr silicone oil; and 1 phr carbon black. Properties of molded test parts are shown in the table. Examples 44 and 45 are replicates of the same composition, as are Examples 51 and 52.

TABLE 5

| | Ex. | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|
| Component | 43 | 44 | 45 | 46 | 47 | 48 | 49 | 50 | 51 | 52 | 53 | 54 | 55 | 56 |
| ASA | 40 | 40 | 55 | 55 | 70 | 70 | 55 | 40 | 40 | 55 | 55 | 70 | 70 | 55 |
| SAN-2 | 36 | 12 | 18 | 18 | 18 | 6 | 18 | — | — | — | — | — | — | — |
| SAN-3 | — | — | — | — | — | — | — | 36 | 12 | 18 | 18 | 18 | 6 | 18 |
| PMMA | 24 | 48 | 27 | 27 | 12 | 24 | 27 | 24 | 48 | 27 | 27 | 12 | 24 | 27 |
| Vicat, ° C. | 101.4 | 97.2 | 96.9 | 95.7 | 94.1 | 88.0 | 97.2 | 99.8 | 98.3 | 94.8 | 95.3 | 90.4 | 89.4 | 94.4 |
| HDT, ° C. | 95.0 | 92.1 | 93.1 | 93.4 | 93.7 | 91.9 | 93.1 | 94.8 | 92.4 | 92.6 | 93.1 | 93.6 | 92.2 | 92.8 |
| MFR, g/10 min. | 17.8 | 11.2 | 9.1 | 9.6 | 5.8 | 4.2 | 9.4 | 10.1 | 9.4 | 6.6 | 6.2 | 3.3 | 3.2 | 6.7 |
| Viscosity, | | | | | | | | | | | | | | |
| Pa · s | | | | | | | | | | | | | | |
| at 100 s−1 | 432 | 516 | 602 | 613 | 754 | 794 | 598 | 622 | 609 | 698 | 726 | 868 | 844 | 716 |
| at 1000 s−1 | 136 | 152 | 162 | 162 | 181 | 186 | 161 | 160 | 162 | 173 | 176 | 193 | 191 | 174 |

Compositions of the invention comprising ASA, PMMA, and either SAN-2 or SAN-3 show HDT values and Vicat temperatures similar to those of similar examples in Table 1 even though these types of SAN are not miscible with PMMA. In contrast SAN-1 used in certain Examples in Table 1 is miscible with PMMA.

### EXAMPLES 57-62 AND COMPARATIVE EXAMPLES 13-18

In the compositions of the following examples and comparative examples ASA; MMA-ASA-3; SAN-1, and MMA-SAN were as described in examples above. All of the compositions comprised 0.5 phr EBS wax; 1.5 phr of a mixture of hindered phenolic anti-oxidants, ultraviolet light absorbers, and phosphorus-comprising stabilizers; and 5 phr titanium dioxide. The proportions of components in the examples and comparative examples are shown in the table.

TABLE 6

| | C. Ex. | | C. Ex. | | C. Ex. | | C. Ex. | | C. Ex. | | C. Ex. | |
|---|---|---|---|---|---|---|---|---|---|---|---|---|
| Component | 13 | Ex. 57 | 14 | Ex. 58 | 15 | Ex. 59 | 16 | Ex. 60 | 17 | Ex. 61 | 18 | Ex. 62 |
| ASA | 33.3 | 33.3 | — | — | 50 | 50 | — | — | 66.7 | 66.7 | — | — |
| MMA- | — | — | 33.3 | 33.3 | — | — | 50 | 50 | — | — | 66.7 | 66.7 |
| ASA-3 | | | | | | | | | | | | |
| SAN-1 | — | 35.6 | — | 35.6 | — | 26.7 | — | 26.7 | — | 17.8 | — | 17.8 |
| MMA- | 66.7 | — | 66.7 | — | 50 | — | 50 | — | 33.3 | — | 33.3 | — |
| SAN | | | | | | | | | | | | |
| PMMA | — | 31.1 | — | 31.1 | — | 23.3 | — | 23.3 | — | 15.5 | — | 15.5 |
| Vicat, ° C. | 95.4 | 98.8 | 95.0 | 98.2 | 93.4 | 95.6 | 91.9 | 94.6 | 87.0 | 90.2 | 85.9 | 89.0 |
| HDT, ° C. | 89.2 | 93.8 | 89.0 | 91.8 | 90.4 | 92.8 | 88.4 | 92.4 | 91.7 | 92.9 | 88.8 | 90.6 |
| MFR, | 18.9 | 23.9 | 17.9 | 24.9 | 8.4 | 13.4 | 8.2 | 11.8 | 4.2 | 4.7 | 3.3 | 5.3 |
| g/10 min. | | | | | | | | | | | | |
| Viscosity, | | | | | | | | | | | | |
| Pa · s | | | | | | | | | | | | |
| at 100 s−1 | 610 | 413 | 598 | 435 | 776 | 592 | 677 | 624 | 844 | 844 | 882 | 926 |
| at 1000 s−1 | 162 | 133 | 160 | 134 | 192 | 158 | 174 | 165 | 192 | 190 | 202 | 201 |
| at 1500 s−1 | 124 | 104 | 122 | 105 | 146 | 121 | 133 | 126 | 145 | 143 | 152 | 151 |

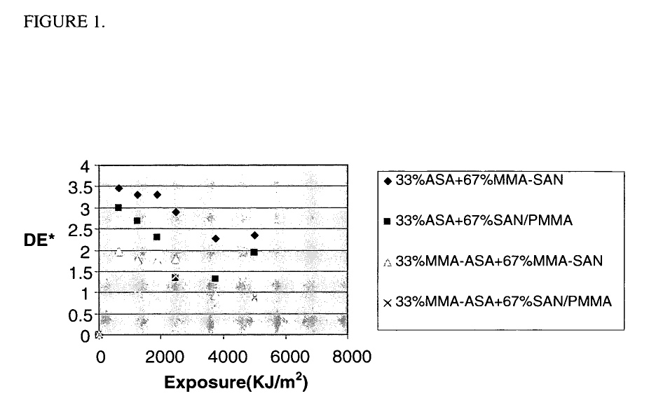

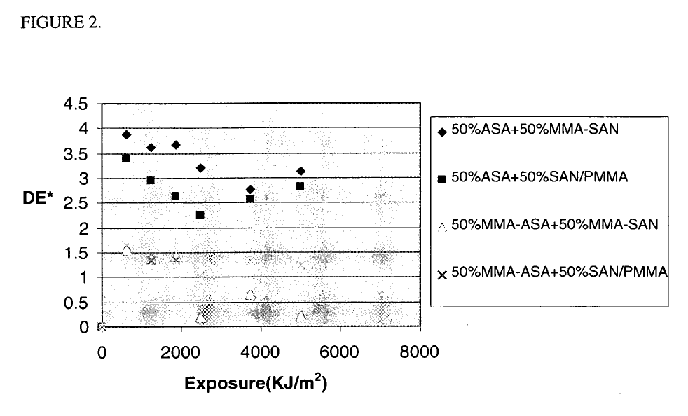

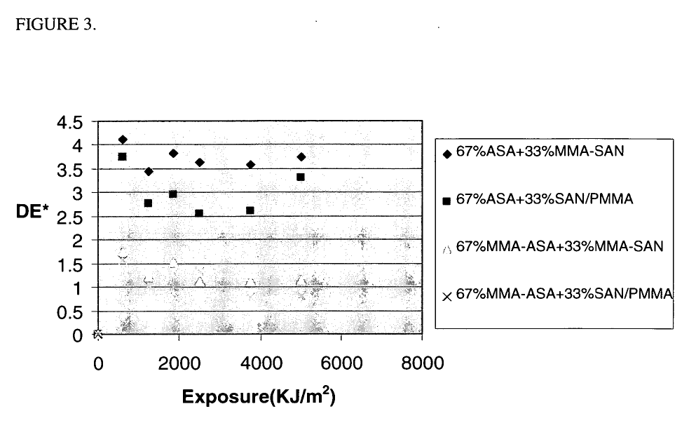

Compositions of the invention comprising SAN, PMMA and either MMA-ASA or ASA show higher HDT and Vicat values, and generally higher flow compared to comparative examples comprising MMA-SAN and either MMA-ASA or ASA. Compositions of the invention and comparative compositions were molded and subjected to accelerated weathering under the SAE J1960 protocol through 5000 kilojoules per square meter exposure (kJ/m²) (measured at 340 nm). FIGS. 1, 2, and 3 show the results of color retention measured as a function of exposure (CIELAB delta E* versus cumulative exposure in kJ/m²). FIGS. 1, 2, and 3 are for compositions of the invention and comparative compositions comprising 33%, 50% and 67%, respectively, of either ASA or MMA-ASA-3. The figures demonstrate that compositions of the invention comprising PMMA exhibit enhanced resistance to color change during accelerated weathering compared to the comparative compositions without PMMA in most embodiments.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A composition comprising: (i) a rubber modified thermoplastic resin comprising a discontinuous elastomeric phase dispersed in a rigid thermoplastic phase, wherein at least a portion of the rigid thermoplastic phase is grafted to the elastomeric phase, and wherein the elastomeric phase comprises a polymer having structural units derived from at least one (C₁-C₁₂)alkyl(meth)acrylate monomer; (ii) a second polymer consisting essentially of structural units derived from at least one (C₁-C₁₂)alkyl(meth)acrylate monomer; and optionally (iii) a third polymer comprising structural units derived from at least one alkenyl aromatic monomer and at least one monoethylenically unsaturated nitrile monomer prepared in a separate polymerization step and added to the composition.

2. The composition of claim 1, wherein the elastomeric phase comprises a polymer having structural units derived from butyl acrylate.

3. The composition of claim 1, wherein the polymer of the elastomeric phase further comprises structural units derived from at least one polyethylenically unsaturated monomer.

4. The composition of claim 3, wherein the polyethylenically unsaturated monomer is selected from the group consisting of butylene diacrylate, divinyl benzene, butene diol dimethacrylate, trimethylolpropane tri(meth)acrylate, allyl methacrylate, diallyl methacrylate, diallyl maleate, diallyl fumarate, diallyl phthalate, triallyl methacrylate, triallyl isocyanurate, triallyl cyanurate, the acrylate of tricyclodecenylalcohol and mixtures thereof.

5. The composition of claim 1, wherein the elastomeric phase comprises about 10 wt. % to about 80 wt. % of the rubber modified thermoplastic resin.

6. The composition of claim 1, wherein the elastomeric phase comprises about 35 wt. % to about 80 wt. % of the rubber modified thermoplastic resin.

7. The composition of claim 1, wherein at least about 5 wt. % to about 90 wt. % of rigid thermoplastic phase is chemically grafted to the elastomeric phase, based on the total amount of rigid thermoplastic phase in the composition.

8. The composition of claim 1, wherein the rigid thermoplastic phase comprises structural units derived from at least one monomer selected from the group consisting of vinyl aromatic monomers, monoethylenically unsaturated nitrile monomers, (C₁-C₁₂)alkyl- and aryl-(meth)acrylate monomers, and mixtures thereof.

9. The composition of claim 1, wherein the rigid thermoplastic phase comprises structural units derived from styrene and acrylonitrile; or styrene, alpha-methyl styrene, and acrylonitrile; or styrene, acrylonitrile, and methyl methacrylate; or alpha-methyl styrene, acrylonitrile and methyl methacrylate; or styrene, alpha-methyl styrene, acrylonitrile and methyl methacrylate.

10. The composition of claim 9, wherein the rigid thermoplastic phase comprises structural units derived from styrene, acrylonitrile, and methyl methacrylate and the initial elastomeric phase is selected from the group consisting of an elastomeric phase with a particle size distribution in a range of between about 80 nm and about 400 nm; an elastomeric phase with a particle size distribution in a range of between about 400 nm and about 750; an elastomeric phase with a broad, essentially monomodal particle size distribution, and mixtures of these elastomeric phases.

11. The composition of claim 1, wherein the second polymer comprises poly(methyl methacrylate).

12. The composition of claim 1, wherein the second polymer is present in a range of between about 3 wt. % and about 70 wt. % based on the weight of resinous components in the composition.

13. The composition of claim 1, wherein the third polymer is present.

14. The composition of claim 12, wherein the third polymer comprises structural units derived from styrene and acrylonitrile; alpha-methylstyrene and acrylonitrile; or alpha-methylstyrene, styrene, and acrylonitrile.

15. The composition of claim 12, wherein the third polymer is present in an amount of between about 5 wt. % and about 90 wt. %, based on the weight of resinous components in the composition.

16. The composition of claim 1 further comprising at least one additive selected from the group consisting of a stabilizer; a color stabilizer; a heat stabilizer; a light stabilizer; an antioxidant; a UV screener; a UV absorber; a flame retardant; an anti-drip agent; a lubricant; a flow promoter; a processing aid; a plasticizer; an antistatic agent; a mold release agent; an impact modifier; a filler; a colorant; a dye; a pigment; metal flakes; a mixture of at least one metal salt of a fatty acid and at least one amide; and mixtures thereof.

17. An article made from the composition of claim 1.

18. A composition comprising: (i) a rubber modified thermoplastic resin comprising a discontinuous elastomeric phase dispersed in a rigid thermoplastic phase, wherein at least a portion of the rigid thermoplastic phase is grafted to the elastomeric phase, and wherein the elastomeric phase comprises a polymer having structural units derived from butyl acrylate; (ii) a second polymer present in a range of between about 3 wt. % and about 70 wt. % based on the weight of resinous components in the composition and consisting essentially of structural units derived from methyl methacrylate; and optionally (iii) a third polymer comprising structural units derived from at least one alkenyl aromatic monomer and at least one monoethylenically unsaturated nitrile monomer prepared in a separate polymerization step and added to the composition.

19. The composition of claim 1, wherein the third polymer is present.

20. The composition of claim 19, wherein the third polymer comprises structural units derived from styrene and acrylonitrile; alpha-methylstyrene and acrylonitrile; or alpha-methylstyrene, styrene, and acrylonitrile.

21. The composition of claim 19, wherein the third polymer is present in an amount of between about 5 wt. % and about 90 wt. %, based on the weight of resinous components in the composition.

22. The composition of claim 18 further comprising at least one additive selected from the group consisting of a stabilizer; a color stabilizer; a heat stabilizer; a light stabilizer; an antioxidant; a UV screener; a UV absorber; a flame retardant; an anti-drip agent; a lubricant; a flow promoter; a processing aid; a plasticizer; an antistatic agent; a mold release agent; an impact modifier; a filler; a colorant; a dye; a pigment; metal flakes; a mixture of at least one metal salt of a fatty acid and at least one amide; and mixtures thereof.

23. An article made from the composition of claim 18.
